(19) United States
(12) Patent Application Publication
(10) Pub. No.: US 2025/0135945 A1
(43) Pub. Date: May 1, 2025

(54) BATTERY MODULES AND PACKS WITH ACTIVE DISPLAY

(71) Applicant: Cummins Inc., Columbus, IN (US)

(72) Inventors: J. Steven Kolhouse, Columbus, IN (US); Yujun Wang, Columbus, IN (US); Matthew D. Nelson, Medford, OR (US); Jordan Loos, Columbus, IN (US); Richard J. Ancimer, Toronto (CA)

(21) Appl. No.: 18/931,461

(22) Filed: Oct. 30, 2024

Related U.S. Application Data
(60) Provisional application No. 63/546,689, filed on Oct. 31, 2023.

(51) Int. Cl. B60L 58/12; B60L 58/16; B60L 58/18; B60R 16/033

(52) U.S. Cl. CPC B60L 58/12; B60L 58/16; B60L 58/18; B60R 16/033; B60L 2250/16

(57) ABSTRACT

In some implementations, a device may include a cell arrangement that stores energy for operating an energy storage system. In addition, the device may include a display that is positioned at the battery and configured to receive service information from the management system and to display the service information that relates to the cell arrangement such that at least one of a serviceability and condition of the battery is decipherable by viewing the display.

### CROSS-REFERENCE TO RELATED PATENT APPLICATIONS

The present application claims the benefit of priority to U.S. Provisional Patent Application No. 63/546,689, filed Oct. 21, 2023, the content of which is incorporated herein by reference in its entirety.

### TECHNICAL FIELD

The present invention relates to techniques for servicing battery modules and battery packs. The invention has particular, but not exclusive, application to battery cells for use in battery packs for use in traction applications, such as electric or hybrid electric vehicles, construction equipment and the like.

### BACKGROUND

Electric and hybrid electric vehicles, such as automobiles, buses, vans and trucks, use battery packs designed to have a high amp-hour capacity to provide power for sustained periods of time. A battery pack includes a large number of individual electrochemical cells connected in series and parallel to achieve overall voltage and current requirements. Typically, lithium ion (li-ion) battery cells are used because they provide relatively good cycle life and energy density.

Battery packs for electric vehicle applications tend to deteriorate during use due to the heavy duty cycles typically encountered. When the battery packs no longer meet the electric vehicle performance standards, they may need to be replaced.

### SUMMARY

In some implementations, a device may include a cell arrangement that stores energy for operating the high-voltage system. In addition, the device may include a display that is positioned at the battery and configured to receive service information from the management system and to display the service information that relates to the cell arrangement such that at least one of a serviceability and condition of the battery is decipherable by viewing the display.

In some implementations, the device may include a battery module arrangement that includes a plurality of battery modules, the battery module arrangement is configured to store energy for operating the electrified vehicle. In addition, the device may include at least one active display that is peripherally arrangeable at one or more of the battery modules in the plurality of batter modules or the battery pack, the active display is configured to readily display service information that relates to at least one of the battery modules in the plurality of battery modules such that serviceability of at least one of the battery module and the battery pack is readily decipherable by viewing the active display.

In some implementations, the device may include receiving service information that relates to the serviceability of the battery module. In addition, the device may include displaying, via an active display that is viewable from a vantage point that is exterior to the battery module, the service information such that the service information is readily decipherable by viewing the active display.

Advantages and features of the embodiments of this disclosure will become more apparent from the following detailed description of exemplary embodiments when viewed in conjunction with the accompanying drawings.

### BRIEF DESCRIPTION OF THE DRAWINGS

FIG. 1 is a schematic of an electrified vehicle;

FIG. 2 is a partial cutaway illustration of a battery module;

FIG. 3 is a scorecard for a battery pack; and

FIG. 4 is a flowchart of a method for servicing a battery pack according to principles of the present disclosure.

### DETAILED DESCRIPTION

For the purposes of promoting an understanding of the principles of the present disclosure, reference is now made to the embodiments illustrated in the drawings, which are described below. The exemplary embodiments disclosed herein are not intended to be exhaustive or to limit the disclosure to the precise form disclosed in the following detailed description. Rather, these exemplary embodiments were chosen and described so that others skilled in the art may utilize their teachings. It is not beyond the scope of this disclosure to have a number (e.g., all) the features in a given embodiment to be used across all embodiments.

Described herein are devices, systems, and method related to the use of energy storage systems (“ESS”), such as high-voltage ESSes, that feature a visible indicator as to their Remaining Useful Life (“RUL”) and/or State of Health (“SOH”). Stationary Energy Storage Systems (“SESS”) represent an opportunity to repurpose (second life) used battery modules before sending them off for recycling. A battery module's battery management system (“BMS”) will contain significant useful data on the batteries age, usage, SOC, SOH, faults, etc. This information is needed to make a proper decision on continued use, repurposing, or recycling of a given module, but it can be cumbersome and time consuming to access & determine for each battery module. However, when presented with a collection of used battery modules to choose from, a core center would need access to access multiple BMS systems in order to determine which batteries are suitable for repurposing into SESes, and which are ready for (in need of) a full recycling process.

The present disclosure includes SESSes that have an externally visible display (e.g., one per individual or a set of battery modules). Information to be displayed can be sourced from a battery module's standalone BMS system, and in addition or in alternative, it can be externally sourced (e.g., from an external BMS). Such a configuration allows for quick sorting and/or disposition of loose battery modules. For instance, such SESSes can include battery modules and/or battery packs with a peripheral or external RUL/SOH indicator, such as a display. The display could be an LED type display, for example, with an interactive user interface that allows for input via touchscreen or push-button selector. In this way, a user could access different fields of available information.

One or more indicia related to individual battery modules or battery packs can be readily deciphered from viewing the display. For instance, the display (e.g., an analog, digital, and/or LED display) can provides specific data related to RUL and/or SOH. The display can provide a simple status indication (e.g., a Red/Yellow/Green light that indicates a level of readiness and/or usability of the battery). Available information for display can include specific data (e.g., age, number of deep cycles, SOC, etc.) or calculated data based on an algorithm internal to the BMS (e.g., cumulative number of deep cycles to date, effective age, estimated RUL, R/Y/G State-of-Health color indicator, etc.). Notably, this display can be a standalone display that is integrated into a battery pack and/or battery modules. In this regard, when installed, the display will be separate from any in-cabin displays such that the serviceability, condition (e.g., real-time status/state), and/or usability of a battery pack and/or battery modules apart from the electrified vehicle.

When implemented, principles of the present disclosure provide many operational advantages. For instance, ESSes can be readily constructed by selecting & using “used” battery modules with a similar RUL. In addition, or in alternative, a system “scorecard” can serve as a useful way to communicate SOH for individual battery modules contained within a system (or array) of battery modules. The system information would be compiled from the BMS of individual battery modules, and it could represent an at-a-glance view of the battery pack within a SESS, vehicle, or piece of equipment.

Principles of the present disclosure can be used in addition or in alternative to “external” test circuits/apparatus that are connected to the battery to determine existing SOC as are necessary for lead-acid batteries that do not have their own BMS systems. Example implementations disclosed herein have a display that is integrated into the battery module itself such that an external apparatus and/or load test is not required because the relevant information is already available within the BMS. This information is then displayed in an external manner (e.g., using one or more displays). Such configurations enable quick determinations & selections of a battery having a certain age, charge, and/or RUL (e.g., for a fleet owner trying to replace and/or maintain an array of similar batteries).

Improvements to product/consumer safety can be seen when implementing principles of the present disclosure. Today, in the absence of such a visible display, a vehicle (or fleet) manager will be forced (or tempted) to insert probes into a high voltage battery to assess the SOC and/or usability of the battery. This can be quite dangerous with high voltage batteries. Using principles of the present disclosure, this manage can, at-a-glance, view such information about one or more battery pack within a SESS, vehicle, or piece of equipment. Further details about the present disclosure are discussed at length hereinafter.

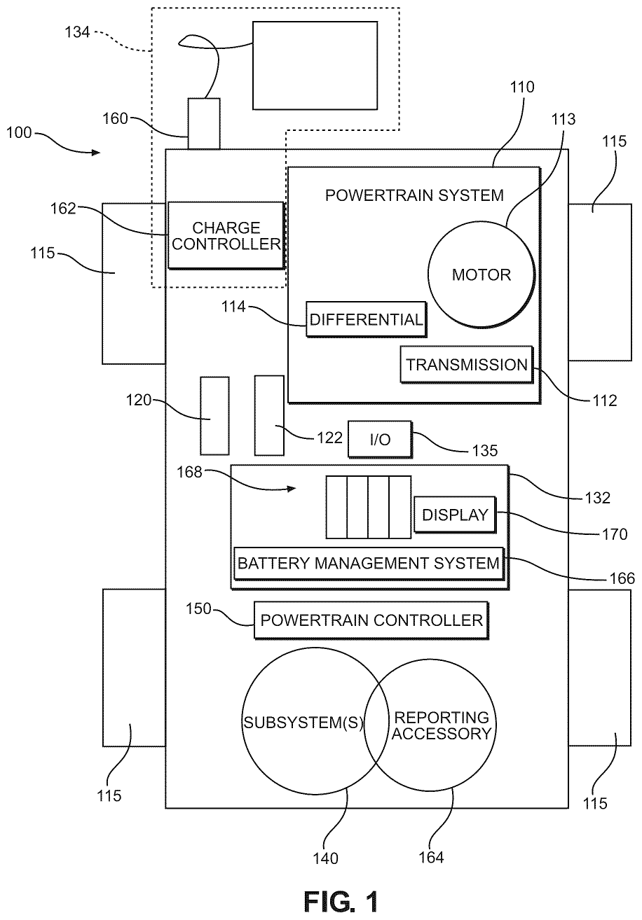

Referring initially to FIG. 1, a schematic diagram of a battery electric vehicle 100 is provided. While the vehicle is referred to as a battery electric vehicle, it is understood that the vehicle may include a hybrid vehicle, such as a plug-in hybrid vehicle, powered or otherwise operable via a battery and, optionally, one or more of a generator (e.g., a power generator, generator plant, electric power strip, on-board rechargeable electricity storage system, etc.) and a motor (e.g., an electric motor, traction motor, etc.). Battery electric vehicle 100 may be operable in at least one of a reverse direction (e.g., a backward direction relative to a front end of battery electric vehicle 100) and a non-reverse direction (e.g., a forward direction, angular direction, etc., relative to the front end of battery electric vehicle 100). Battery electric vehicle 100 may be an on-road or off-road vehicle including, but not limited to, cars, trucks, ships, boats, vans, airplanes, spacecraft, or any other type of vehicle.

Battery electric vehicle 100 comprises a powertrain controller 150 communicably and operatively coupled to a powertrain system 110, a brake mechanism 120, an accelerator pedal 122, one or more sensors, an operator input/output (I/O) device 135, and one or more additional vehicle subsystems 140. Battery electric vehicle 100 may include additional, fewer, and/or different components systems than depicted in FIG. 1, such that the principles, methods, systems, apparatuses, processes, and the like of the present disclosure are intended to be applicable with any suitable vehicle configuration. It should also be understood that the principles of the present disclosure should not be interpreted to be limited to on-highway vehicles; rather, the present disclosure contemplates that the principles may also be applied to a variety of other applications including, but not limited to, off-highway construction equipment, mining equipment, marine equipment, locomotive equipment, etc.

Powertrain system 110 facilitates power transfer from a battery 132 and/or a motor 113 to power battery electric vehicle 100. In an exemplary embodiment, powertrain system 110 includes motor 113 operably coupled to battery 132 and charge system 134, where motor 113 transfers power to a final drive (e.g., wheels 115) to propel battery electric vehicle 100. As depicted, powertrain system 110 may include other various components, such as a transmission 112 and/or differential 114, where differential 114 transfers power output from transmission 112 to final drive 115 to propel battery electric vehicle 100. Powertrain controller 150 of battery electric vehicle 100 provides electricity to motor 113 (e.g., an electric motor) in response to various inputs received by powertrain controller 150, for example, from accelerator pedal 122, sensors, vehicle subsystems 140, charge system 134 (e.g., a battery charging system, rechargeable battery, etc.). In some embodiments, electricity provided to power motor 113 may be provided by an onboard gasoline-engine generator, a hydrogen fuel cell, etc.

In some embodiments, battery electric vehicle 100 may include transmission 112. Transmission 112 may be structured as any type of transmission compatible with battery electric vehicle 100, including a continuous variable transmission, a manual transmission, an automatic transmission, an automatic-manual transmission, or a dual clutch transmission, for example. Accordingly, as transmissions vary from geared to continuous configurations, transmission 112 may include a variety of settings (e.g., gears, for a geared transmission) that affect different output speeds based on an engine speed or motor speed. Like transmission 112, motor 113, differential 114, and final drive 115 may be structured in any configuration compatible with battery electric vehicle 100. In some embodiments, transmission 112, is omitted and motor 113 is directly coupled to differential 114. In other embodiments, motor 113 is directly coupled to final drive 115 as a direct drive application. In some examples, battery electric vehicle may comprise multiple instances of motor 113, for example, one instance for each driven wheel, one instance per driven axle, or other compatible arrangements.

Brake mechanism 120 may be implemented as a brake (e.g., hydraulic disc brake, drum brake, air brake, etc.), braking system, or any other device configured to prevent or reduce motion by slowing or stopping components (e.g., a wheel, axle, pedal, crankshaft, driveshaft, etc. of battery electric vehicle 100). Generally, brake mechanism 120 is configured to receive an indication of a desired change in the vehicle speed. In some embodiments, brake mechanism 120 comprises a brake pedal operable between a released state and an applied state by an operator of battery electric vehicle 100. The brake pedal may be configured as a pressure-based system responsive to applied pressure or a travel-based system responsive to a travel distance of the pedal, where a force applied to brake mechanism 120 is proportional to the pressure and/or travel distance. In some embodiments, all or a portion of brake mechanism 120 is incorporated into motor 113, for example, as a regenerative brake mechanism.

Generally, the released state of brake mechanism 120 corresponds to a brake pedal in a default location where the brake mechanism is not applied, for example, when the operator's foot is not placed on the brake pedal at all, or merely resting on the brake pedal such that a minimum actuation force is not exceeded (e.g., a spring-assisted, hydraulic-assisted, or servo-assisted force that pushes the brake pedal to the default location). In some embodiments, the brake pedal is combined with accelerator pedal 122 in a one-pedal driving configuration. In some examples, the applied state of brake mechanism 120 may correspond to the brake pedal being pressed with a force that meets or exceeds the minimum actuation force. In other examples, the applied state of brake mechanism 120 corresponds to the brake pedal being pressed so that the travel distance of the brake pedal meets or exceeds a minimum travel distance. Generally, the minimum actuation force and/or minimum travel distance help to prevent accidental actuation of brake mechanism 120. Different levels of the minimum actuation force and/or minimum travel distance may be used for different implementations of brake mechanism 120, for example, relatively higher forces or travel distance for a foot-actuated brake pedal, relatively lower forces or travel distance for a hand-actuated brake lever. Although the brake pedal may have a range of pressures and/or travel distances that provide at least some braking effect on battery electric vehicle 100 (e.g., high pressures for hard or emergency braking, low pressures for gradual braking or “feathering” the brakes), this range of pressures and/or travel distances are within the applied state.

The released state may correspond to an indication of a desired increase in vehicle speed, while the applied state may correspond to an indication of a desired reduction in vehicle speed. In some embodiments, a reduction in actuation force and/or travel distance corresponds to a desired increase in vehicle speed, while an increase in actuation force and/or travel distance corresponds to a desired reduction in vehicle speed.

Accelerator pedal 122 may be structured as any type of torque and/or speed request device included with a system (e.g., a floor-based pedal, an acceleration lever, paddle or joystick, etc.). Sensors associated with accelerator pedal 122 and/or brake mechanism 120 may include a vehicle speed sensor that provides a vehicle speed signal corresponding to a vehicle speed of battery electric vehicle 100, an accelerator pedal position sensor that acquires data indicative of a depression amount of the pedal (e.g., a potentiometer), a brake mechanism sensor that acquires data indicative of a depression amount (pressure or travel) of brake mechanism 120, a coolant temperature sensor, a pressure sensor, an ambient air temperature, or other suitable sensors.

Battery electric vehicle 100 may include operator I/O device 135. Operator I/O device 135 may enable an operator of the vehicle to communicate with battery electric vehicle 100 and/or powertrain controller 150. Analogously, operator I/O device 135 enables battery electric vehicle 100 and/or powertrain controller 150 to communicate with the operator. For example, operator I/O device 135 may include, but is not limited to, an interactive display (e.g., a touchscreen) having one or more buttons, input devices, haptic feedback devices, an accelerator pedal, a brake pedal, a shifter or other interface for transmission 112, a cruise control input setting, a navigation input setting, or other settings or adjustments available to the operator. Via operator I/O device 135, powertrain controller 150 can also provide commands, instructions, and/or information to the operator or a passenger.

Battery electric vehicle 100 includes one or more vehicle subsystems 140, which may generally include one or more sensors (e.g., a speed sensor, ambient pressure sensor, temperature sensor, etc.), as well as any other subsystem that may be included with a vehicle. Vehicle subsystems 140 may also include torque sensors for one or more of motor 113, transmission 112, differential 114, and/or final drive 115. Other vehicle subsystems 140 may include a steering subsystem for managing steering functions, such as electrical power steering, and output information such as wheel position and fault codes corresponding to steering battery electric vehicle 100; an electrical subsystem which may include audio and visual indicators, such as hazard lights and speakers configured to emit audible warnings, as well as other functions; and a thermal management system, which may include components such as a radiator, coolant, pumps, fans, heat exchangers, computing devices, and associated software applications. Battery electric vehicle 100 may include further sensors other than those otherwise discussed herein, such as cameras, LIDAR, and/or RADAR, temperature sensors, smoke detectors, virtual sensors, among other potential sensors.

Powertrain controller 150 may be communicably and operatively coupled to powertrain system 110, brake mechanism 120, accelerator pedal 122, operator I/O device 135, and one or more vehicle subsystems 140. Communication between and among the components may be via any number of wired or wireless connections. For example, a wired connection may include a serial cable, a fiber optic cable, an SAE J1939 bus, a CAT5 cable, or any other form of wired connection. In comparison, a wireless connection may include the Internet, Wi-Fi, Bluetooth, Zigbee, cellular, radio, etc. In one embodiment, a controller area network (CAN) bus including any number of wired and wireless connections provides the exchange of signals, information and/or data. Powertrain controller 150 is structured to receive data (e.g., instructions, commands, signals, values, etc.) from one or more of the components of battery electric vehicle 100 as described herein via the communicable coupling of powertrain controller 150 to the systems and components of battery electric vehicle 100. In some embodiments, an additional or alternative controller may be used for receiving data from certain systems or components.

In vehicles including charge system 134, such as a plug-in charging system, battery electric vehicle 100 may powertrain controller 150 may control charging of battery 132 when a charger 160 of charge system 134 is connected to battery electric vehicle 100. A charge controller 162 establishes communications between powertrain controller 150 and charger 160.

Charge controller 162 may receive a charge command from powertrain controller 150 and charger 160. Charge controller 162 may monitor sensor signals and perform safety and performance checks and determine faults based thereon. For example, charge controller 162 may determine a fault if charging has started but a physical connection between charger 160 and battery electric vehicle 100 fails to be detected or is detected to be outside safe boundaries. In other words, charge controller 162 may function as a communication interface between charger 160 and powertrain controller 150.

Powertrain controller 150 may be communicably coupled with charger 160, battery 132 and a reporting accessory 164 so that digital data may be transferred between components. Reporting accessory 164 may be include a vehicle subsystem 140 or another vehicle component. A CAN bus may be implemented to provide communications. In some embodiments, a first CAN bus may be implemented to provide communications between a first plurality of components while a second CAN bus may be implemented to provide communications between a second plurality of components. Any series or parallel communication scheme and protocol known in the arm may be implemented to provide communication.

Reporting accessory 164 may be operable to communicate information to powertrain controller 150. Such information may include identification, current demand, high or low voltage power draw, and other information required for operation of battery electric vehicle 100. Identification information may include a maximum current capacity of reporting accessory 164, for example. The current demand may be dynamic, such that the current demanded by reporting accessory 164 varies. Reporting accessory 164 may include an air-conditioning system, for example, and the current demand may vary based on a measured actual temperature of an interior of battery electric battery 100 compared to a target temperature. By reporting current demand to powertrain controller 150, reporting accessory 164 enables powertrain controller 150 to more accurately determine the target current to generate the charge command to charger 162. Comparatively, when the load of a non-reporting accessory is dynamic and unknown, charger 162 may underdeliver current to battery 132, extending charging time. The charge command may also take into account the charger's capability to deliver current and indicates to charger 162 the level of current to output to battery electric vehicle 100, which is ideally sufficient to optimally charge battery 132 and also power the accessories.

Battery 132 may include one or more battery packs including a battery management system 166 and battery modules 168. FIG. 1 is not determinative of the number of battery modules within a battery pack or the number of battery packs within battery 132. Battery 132 may include a greater number of battery packs and/or a greater or lesser number of battery modules. Temperature, voltage, and other sensors may be provided to enable battery management system 166 to manage the charging and discharging of battery modules 168 without exceeding their limits, to detect and manage faults, and to perform other known functions. Battery management system 166 may transmit data to powertrain controller 150 related to information about battery 132, including the battery charge power limit, temperature, faults, etc. Battery 132 may include a current sensor to provide a measured current value to battery management system 166, which may be used to affect the charge command provided to charger 162. The current sensor may be located elsewhere. Multiple current sensors may be used, each current sensor associated with a battery module of battery 132, where the sum of the measured currents being the measured current of battery 132.

Powertrain controller 150 may include a charge logic operable to determine a command for charger 162 to supply a target current to battery 132. The charge logic may also be integrated with a controller of battery management system 166 or provided in a standalone controller communicatively coupled to powertrain controller 150. The term “logic” as used herein includes software and/or firmware comprising processing instructions executing on one or more programmable processors, application-specific integrated circuits, field-programmable gate arrays, digital signal processors, hardwired logic, or combinations thereof, which may be referred to as “controllers”. Therefore, in accordance with the disclosure, various logic may be implemented in any appropriate fashion. A non-transitory machine-readable medium comprising logic can additionally be included within any tangible form of a computer-readable carrier, such as a solid-state memory, containing an appropriate set of computer instructions and data structures that would cause a processor to carry out the techniques described herein. A non-transitory computer-readable medium, or memory, may include random access memory (RAM), read-only memory (ROM), erasable programmable read-only memory (e.g., EPROM, EEPROM, or Flash), or any tangible medium capable of storing information.

A transport control system and charging system may communicatively connect multiple chargers and control charging processes in a depot, linking charging points, power supplies, and operational information systems, such as planning and scheduling systems. The transport control system may provide the charging management system information such as estimated arrival time of vehicles, time available for charging, and scheduled pull-out time. The charging management system can then calculate the charging requirements for each vehicle and optimize charging processes for the fleet of vehicles to, for example, avoid expensive grid peak load periods where possible. The charging management system may also assign time slots for charging to each vehicle and monitor the progress of charging of each vehicle. The charging management system may receive from each vehicle an estimated time to full charge. In other embodiments, the vehicle may provide the relevant data to the charging management system, which may then estimate the time to full charge within its control logic.

Although FIG. 1 is described as illustrating a battery electric vehicle, the disclosure provided herein may also apply to vehicles having other powertrains, such as, for example, a plug-in hybrid vehicle. In such embodiments, the vehicle optionally includes an engine which may be structured as an internal combustion engine that receives a chemical energy input (e.g., a fuel such as natural gas, gasoline, ethanol, or diesel) from a fuel delivery system, and combusts the fuel to generate mechanical energy, in the form of a rotating crankshaft. In such an embodiment, transmission receives the rotating crankshaft and manipulates the speed of the crankshaft (e.g., the engine speed, which is usually expressed in revolutions-per-minute (RPM)) to affect a desired draft shaft speed. A rotating drive shaft may be received by differential, which provides the rotation energy from the drive shaft to final drive, which then propels or moves the vehicle.

Further toward principles of the present disclosure, serviceability of a battery pack 132 for an electrified vehicle 100 can be improved by using an active display. For instance, the battery pack 132 can include a battery module arrangement with a plurality of battery modules 168 configured to store energy for operating the electrified vehicle 100. The battery pack 132 can include at least one active display 170 that is peripherally arrangeable at the battery module 168 or the battery pack 132. In this regard, serviceability of the at least one battery module 168 and the battery pack 132 is readily decipherable by viewing the active display. The active display can be configured to readily display service information that relates to the at least one of the battery modules 168 in the plurality of battery modules 168. There can be single or multiple peripheral displays that are associated with each of the battery modules 168 in the plurality of battery modules 168. In this regard, each of the active displays can be arranged to be visible at a glance from a vantage point that is exterior to the battery module 168 and/or the battery pack 132. A casing (e.g., shown generally at 132) of the battery pack 132 can facilitate arranging the plurality of battery modules 168 into the battery module 168 arrangement. Such arrangements include forming an array of battery modules 168 such that the peripheral display of each of the battery modules 168 in the plurality of battery modules 168 is prominently displayed. As discussed in further detail below, an active display can include a scorecard that displays indicia of the service information for each or a select number of the battery modules 168 in the plurality of battery modules 168.

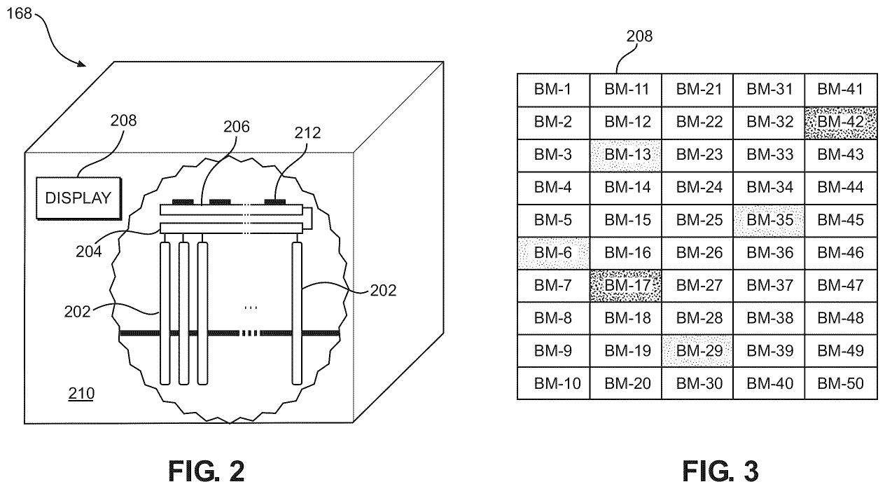

In more detail, FIG. 2 shows parts of a battery module 168. Referring to FIG. 2, the battery module 168 comprises one or more (e.g., a single or plurality) of battery cells 202, a busbar 204, and a battery management unit 206. In this embodiment, the battery cells 202 are pouch cells or prismatic cells stacked together side-by-side. However, other types of cell, such as cylindrical cells, could be used instead. The busbar 204 is used to connect the battery cells 202 in the required series/parallel configuration. The busbar 204 includes voltage sensors which monitor the voltages of individual battery cells, or groups of battery cells connected in parallel. A current sensor senses total current through the module. In addition, one or more temperature and/or pressure sensors are used to sense the temperature and/or pressure of the module. The busbar 204 is connected to the battery management unit 206. The battery management unit 206 receives the sensed voltages, current and temperature. The sensed voltages, current and temperature are used to monitor and manage cell charge and discharge.

Such a battery module 168 can be configured for serviceable integration into a battery pack 132 for an electrified vehicle. The battery module 168 includes a cell arrangement (e.g., of the one or more battery cells 202) and a display 208. The cell arrangement stores energy for operating the electrified vehicle. The display 208 can be an active display 208, such as a selectively active or persistently active display 208. As shown, the display 208 is arrangeable at a periphery of the battery module 168, for example at a position external to the cell arrangement (such as a casing 210 of the battery module 168 or an associated battery pack 132). In examples, the active display 208 is configured to display service information that relates to the cell arrangement such that serviceability of the battery module 168 is decipherable by viewing the active display 208.

Service information for the active display 208 can be sourced from the battery management system. Service information includes any information that is helpful in servicing or selecting a use for a battery module 168, including indications of at least one of battery age, remaining life, state-of-health, state-of-charge, battery management system health, and faults. The battery management system used to source service information for the active display 208 can be any battery management system in the energy storage system. For instance, the battery management system can be that of one or a set of battery modules 168. In this regard, the battery management system can be integrated as a standalone or remote feature to the battery module 168. For instance, communication (e.g., wired or wireless communication) between the battery management system and the active display 208 can be established via a processor 212 and a circuitry (not shown). Such a processor 212 can be configured to receive the service information at the active display 208 and/or transmit the service information to the active display 208. In examples, the processor 212 is integrated into the active display 208. In examples, the processor 212 is integrated into a management system that manages the battery module 168 such as a battery management system of the electrified vehicle and/or a standalone management system of the battery module 168.

A battery module casing that encases the cell arrangement can be used to position the active display 208. For instance, in this manner the active display 208 can be peripherally arranged at the battery module 168 such that the service information is decipherable at a glance from a vantage point that is external to the cell arrangement and/or battery module 168.

Power to operate the active display 208 can be drawn from one or more sources. For instance, the active display 208 can be powered by one or more of the battery modules 168, including the battery module 168 of interest. On the other hand, the active display 208 can be powered externally by a test rig or the electrified vehicle. As implementations vary, the battery module 168 can be selectively powered between any of these sources. Advantageously, there are efficiency gains made when the active display 208 is powered by the battery module 168 of interest. For instance, under these circumstances an operator can access the service information at the battery module 168 where it stands.

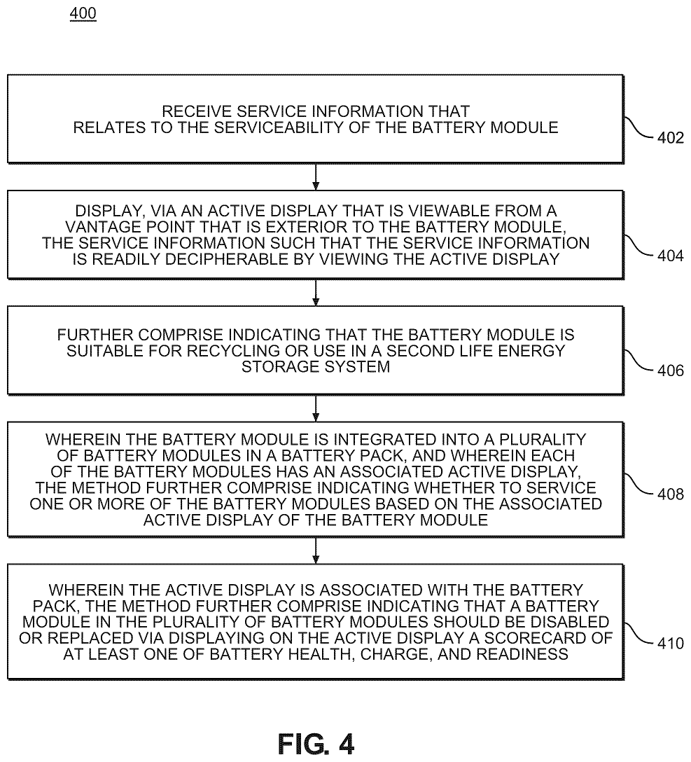

In examples, the service information indicates a degree to which the battery module is serviceable. As can be seen in FIG. 3, the display 208 can provide a simple status indication (e.g., a Red/Yellow/Green light) that indicates a level of readiness and/or usability of the battery module. For instance, a red light can indicate that the battery module should be recycled, a yellow light can indicate that the battery module is appropriate for second-use applications, and a green light can indicate that the battery module is appropriate for its current application. On the other hand, the indication can be a degree to which the battery is appropriate for a particular application (e.g., green means good, yellow means caution, and red means no good) such as second-use applications. Available information for display 208 can include specific data (e.g., age, number of deep cycles, SOC, etc.) or calculated data based on an algorithm internal to the battery management unit (e.g., cumulative number of deep cycles to date, effective age, estimated RUL, R/Y/G State-of-Health color indicator, etc.). When associated with a plurality of battery modules, such as those arranged within a battery pack or a serviceable subset thereof, the display 208 can serve as a scorecard that displays indicia of the service information for each or a select number of the battery modules in the plurality of battery modules. This scorecard can be used to service the battery pack, such as indicating that certain battery modules in the battery pack need replacement.

As a practical example, the scorecard in FIG. 3 provides several indications that can facilitate servicing a battery pack. There are 50 battery modules (“BM”) shown. BM-6, BM-13, BM-29, and BM-35 each show a yellow or cautionary indication. And BM-17 and BM-42 show a red or no-go indication. An operator servicing a battery pack with this scorecard can determine or receive a recommendation from the battery management unit that the battery modules with a red or no-go indication can be disabled to restore functionality of the battery pack, albeit compromised. Such a battery may be used in a limp-home or salvage scenario where long-term battery pack operation is not critical. To return the battery to optimal performance, an operator can determine or receive a recommendation from the battery management unit to replace battery modules that have either the no-go or cautionary indications. These are just some examples of what the active display 208 can readily provide the operator at a glance or with minimal interaction with the display 208.

Various functions and methods disclosed herein can be performed by a processor executing instructions that are stored on a computer-readable medium. For instance, a non-transitory computer-readable medium storing a set of instructions for servicing a battery module. The set of instructions can include one or more instructions that, when executed by one or more processors of a device, cause the device to receive service information that relates to the serviceability of the battery module. In addition, or in alternative, such instructions can cause the device to display, via an active display 208 that is viewable from a vantage point that is exterior to the battery module, the service information such that the service information is readily decipherable by viewing the active display 208. The active display 208 can be similar to those discussed herein, including those discussed in relation to FIGS. 1-3.

The instructions can include any functions discussed in relation to those figures as well as those discussed in various methods discussed throughout this disclosure. For instance, the one or more instructions can further cause the device to indicate that the battery module is suitable for recycling or use in a second life energy storage system. As noted above, in examples the battery module is integrated into a plurality of battery modules in a battery pack, and each of the battery modules has an associated active display. Under these circumstances, the one or more instructions can further cause the device to indicate whether to service one or more of the battery modules based on the associated active display of the battery module. As noted above, in examples the active display is associated with the battery pack. Under these circumstances, the one or more instructions can further cause the device to indicate that a battery module in the plurality of battery modules should be disabled or replaced via displaying on the active display that is associated with a scorecard of battery health, charge, or readiness.

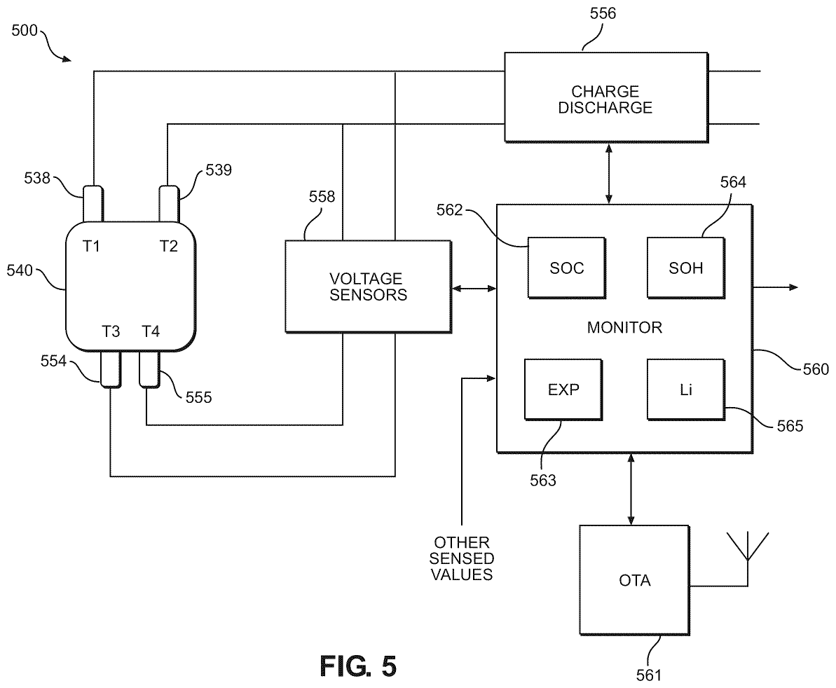

FIG. 4 is a flowchart of certain methods disclosed herein. Illustrated here is a method of servicing a battery module. In some implementations, one or more process blocks of FIG. 4 may be performed by a device.

As shown, the method 400 can include receiving service information that relates to the serviceability of the battery module (block 402). The method 400 can include displaying the service information such that the service information is readily decipherable by viewing the active display (block 404). This displaying can be performed using an active display that is viewable from a vantage point that is exterior to the battery module. The active display can be similar to those discussed above. The method 400 can include indicating that the battery module is suitable for recycling or use in a second life energy storage system. When the battery module is integrated into a plurality of battery modules in a battery pack and each of the battery modules has an associated active display, for instance, the method can include indicating whether to service one or more of the battery modules based on the associated active display of the battery module. When the active display is associated with the battery pack, for instance, the method can include indicating that a battery module in the plurality of battery modules should be disabled or replaced via displaying on the active display a scorecard of battery health, charge, and/or readiness.

The method 400 may include additional implementations, such as any single implementation or any combination of implementations described below and/or in connection with one or more other processes described elsewhere herein. A first implementation, process 400 may include indicating that the battery module is suitable for recycling or use in a second life energy storage system.

In a second implementation, alone or in combination with the first implementation, the battery module is integrated into a plurality of battery modules in a battery pack, and where each of the battery modules has an associated active display, the method may include indicating whether to service one or more of the battery modules based on the associated active display of the battery module.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

Without reference to any particular figure, it is acknowledged that different external enclosures or casings for battery modules and/or battery packs can be useful and customizable to different applications. For instance, such casings can be ruggedized and easily manufactured while improving shock, vibration, low temperature performance, accommodation of cell swelling, cost effectiveness, and the like. On the other hand, a battery pack employing principles of the present disclosure can include encapsulated battery cells without any additional external enclosure. In such an embodiment, an encapsulant can form at least a portion of the exterior surface of the battery pack. Further, disclosed are examples in which the encapsulant fully encapsulates the battery cells (e.g., with the electrode leads of the cells extending through the encapsulant are also described). Further still, examples in which the battery cells are at least partially encapsulated and are located within a rigid outer housing are also detailed herein. This housing in some examples can be filled with encapsulant. While any appropriate material may be used as an encapsulant, appropriate encapsulants include but are not limited to elastomers (e.g. silicones), epoxies, and/or any other appropriate material. In one specific embodiment, an encapsulant is a flexible polyurethane/polyurea blend. And in any of these instances where the battery cells are encapsulated, the display can be integrated into the encapsulation. Contemplated, however, are embodiments where the display is freestanding.

The examples described herein may refer to battery modules (e.g., single or cell module assemblies and the like) and/or battery packs (e.g., module-to-pack or cell-to-pack assemblies and the like). However, it should be understood that these terms may be used interchangeably in the various examples to refer to a grouping of one or more electrically interconnected electrochemical cells. For instance, “battery” can be used herein to either or both battery modules and battery packs.

As used herein, terms electrochemical cells, cells, and similar terms are meant to refer to individual battery cells such as coin cells, prismatic cells of various shape, jelly roll cells, pouch cells, or any other appropriate electrochemical device capable of acting as a battery. Additionally, a pouch cell, electrochemical pouch cell, and other similar terms are meant to refer to cells that include a deformable outer layer that typically includes layers of laminated polymers and metal foils surrounding an internal electrode stack or roll. Typically, pouch cells include larger flat opposing front and back surfaces and smaller side surfaces. Further, when forming stacks of pouch cells, the flat surfaces are typically stacked one on top of the other. However, certain examples may use multiple adjacent cell stacks where the cells are either in series and/or in parallel. In certain embodiments, other ways of arranging the cells may also be employed.

Non-limiting examples of various battery pack configurations and arrangements noted above include battery pack with a battery management unit and/or other associated electronics that provide various types of desired functionality. For instance, such battery packs include a plurality of battery modules electrically connected in series and/or parallel to achieve the target pack voltage. A battery management system monitors the voltage and current and manages overall operation of the battery pack. Each battery module comprises a plurality of battery cells electrically connected in series and/or parallel. Each battery module includes a battery management unit which monitors and manages charge and discharge of the cells in that module.

Although not illustrated or discussed exhaustively herein, one skilled in the art will appreciate that each battery management unit can include various sensors for facilitating serviceability and usability functions discussed elsewhere herein. For instance, voltage sensors can sense the voltages of individual cells or groups of cells. Each battery management unit may also include one or more temperature and/or pressure sensors which sense the temperature and/or pressure of the module and/or individual cells or groups of cells. The battery management system communicates with the battery management unit in each of the modules to monitor and manage overall operation of the battery pack. The battery management system and each of the battery management units include a processor with the appropriate software, along with memory and other components, which are used to monitor and manage charge and discharge. For example, in certain examples, a battery management unit may include circuitry that expands the number of cells for which the battery management unit may perform cell voltage sensing and balancing. In certain examples, the battery management unit may include overvoltage protection monitoring and interlock functionality. Additionally, a battery management unit may include circuitry and/or be programmed to implement a method of active and standby power supply adaption that provides lower active power dissipation. A battery management unit may also include external Flash Memory for more secure program bootloading. Of course, in certain examples battery management units may include combinations of the above noted functionalities and/or different functionalities.

FIG. 5 shows a schematic of an example cell monitoring system 500 for use in the battery modules discussed elsewhere herein. One or more parts of the cell monitoring system 500 can be in communication with the battery management system of the electrified vehicle and/or the battery management unit in an associated battery module. To start, the charge/discharge control module 556 can be used to control charging and discharging of the battery cell 540. The voltage sensor module 558 can include one or more voltage sensors, each of which senses the voltage (i.e., potential difference) across any two of working terminals 538, 539 and reference terminals 554, 555. For example, the voltage sensor module 558 can include a separate voltage sensor across each pair of terminals, or a single voltage sensor that can be switched between different pairs of terminals, or any combination thereof. The sensed voltage values are fed to the cell monitoring module 560.

The cell monitoring module 560 is configured to monitor cell parameters such as state of charge (SOC) and state of health (SOH) based on the sensed voltage values. The cell monitoring module 560 may also be arranged to monitor other cell parameters such as cell expansion and the onset of lithium plating. The cell monitoring module 560 may receive inputs from other sensors such as current sensors and/or temperature sensors for use in monitoring cell parameters. The cell monitoring module 560 outputs values of the monitored parameters (such as SOC and/or SOH) for use in battery monitoring and control. The cell monitoring module 560 may also control the operation of the charge/discharge control module 556 based on the monitored parameters. The cell monitoring module 560 may be implemented, for example, as a software process executing on a processor and may be, for example, part of a battery management unit such as that discussed elsewhere herein.

In one embodiment, the cell monitoring module 560 comprises a SOC determination unit 562 for determining the state of charge of the cell, and a SOH determination unit 564 for determining the state of health of the cell. The cell monitoring module 60 may also comprise an expansion estimation unit 563 and a lithium plating detection unit 565. Operation of the various units 562, 563, 564, 565 will be described in more detail below. Notably, each of these units can include storage that stores correlations between various cell terminal voltages as well as state of charge of the battery cell, the state of heath of the battery cell at various charged and discharged conditions, and correlations between the cell volume and anode SOC and cathode SOC for cell expansion estimation for example.

Various units can be used to supply data for determining service information for use in the battery management units and systems discussed elsewhere herein. The cell monitoring module 560 also comprises a state of charge (SOC) determination unit 562 for estimating a state of charge of the cell, a state of health (SOH) determining unit 564 for determining the state of health of the cell, an expansion (EXP) estimation unit 563 to estimate the expansion of the battery cell based on the anode and cathode SOC levels, and lithium plating detection unit 565 to determine the anode voltage using the voltages between the reference electrodes and the anode. The lithium plating detection unit 565 monitors the anode voltage, and detects when the anode voltage is low enough to initiate lithium plating. This can then be used to control the rate at which the charge/discharge module 556 charges the battery. The cell monitoring module 560 of can also be used to detect battery leakage. the cell monitoring system includes an over-the-air (OTA) module 561 that allows the system to communicate with external systems, for example using radio frequency (RF) transmission. This can allow the system to communicate battery parameters such as SOC and SOH to an operator, for example, an operator of a fleet of vehicles.

Without reference to any particular figure, it is worth noting that in examples the display can be configured to display advanced battery information. For instance, the battery information can include the advanced battery information relating to various battery attributes. Advanced battery information can be used to develop the scorecard discussed elsewhere herein. For some of these attributes listed below, it is helpful for the BMS to be configured to store data and conduct calculations to display the results.

As is the case with battery information, the advanced battery information can be displayed and/or calculated in real time. Examples of advanced battery information include calculations of State of Charge, State of Health, and State of Energy. State of Health can be based on time, throughput, mileage/cycles. In examples, monitoring or detecting a delta SOH divided by delta Throughput curve can enable the BMS to observe sudden changes in that curve. These sudden changes can be an indicator of an issue that warrants servicing or replacing the battery module. For example, servicing or replacing the battery can be recommended (e.g., via the scorecard) when the curve reaches a knee and/or based on the severity of the knee. A moderate knee in the curve can indicate that the battery module needs to be serviced, for example, to prevent further or more severe knees. A severe knee in the curve can indicate that the battery module needs to be replaced (i.e., it has reached end of life or “EoL”). Sudden changes in the curve can also indicate that there has been some unexpected damage sustained. Under these circumstances, depending on the severity of the damage, it can be recommended to service and/or replace the battery module in a similar manner as is done for the knee detection.

Other advanced battery information that can be displayed includes indicia of the following:
Present Temperature-historical max, min and average
Present Humidity-historical max, min and average
Present Voltage-historical max, min and average
Historical Discharge Current (average, max)
Historical Charge/Regen Current (average, max)
Present Cell Internal Resistance-historical max, min and average
Present Cell Impedance-historical max, min and average
Present Cell Pressure-historical max, min and average
Present Pack Air Pressure-historical max, min and average
Age (e.g., days since production and/or in service)
Number of Full (equivalent) Charge/Discharge Cycles
Self-Discharge Rate
Historical shock/vibe exposure
Volatile Fume detector.

For sake of conciseness, this list is non-exhaustive as other like advanced battery information, indicia of advanced battery information, and/or factors affecting the advanced battery information are contemplated as one skilled in the art will appreciate.

Principles described herein can be used in a variety of applications. As alluded to above, battery-powered energy storage systems are widely used in a variety of applications, such as electric vehicles, renewable energy systems, and backup power systems. These systems typically consist of one or more battery packs, a battery management system (BMS), and a power conversion system. The BMS is responsible for monitoring the state of charge, state of health, and temperature of the battery packs, while the power conversion system is responsible for converting the DC voltage of the battery packs into AC voltage for use by the load.

In a battery-powered energy storage system, high-voltage and low-voltage refer to the amount of electrical energy that is stored and used by the system. High-voltage systems typically store and use more energy than low-voltage systems. This is because high-voltage systems use larger batteries with more cells connected in series, which results in a higher overall voltage.

The main advantage of a high-voltage system is that it can deliver more power and energy to the load, which is useful for applications that require high power output such as electric vehicles or large-scale energy storage systems. However, high-voltage systems also require more complex and expensive components to manage the higher voltage levels, such as specialized power electronics and safety features. Low-voltage systems, on the other hand, are simpler and less expensive but may not be suitable for high-power applications.

One consideration when designing a battery-powered energy storage system is the choice between a high-voltage system and a low-voltage system. High-voltage systems typically operate at voltages above 400V, while low-voltage systems typically operate at voltages below 100V. The choice between these two systems depends on a variety of factors, including the power requirements of the load, the cost and efficiency of the power conversion system, and the safety considerations of the system.

The high-voltage energy storage system in an electric vehicle (EV) typically ranges from 200 to 800 volts. The voltage of an EV's battery is usually determined by the size of the vehicle. Passenger vehicles typically use 400 volts. Buses and freight trucks typically use 600 volts. Smaller vehicles can use as little as 12 volts. Higher voltages allow EV manufacturers to create batteries that use fewer materials, which can make them more energy-efficient. 800-volt systems also offer advantages in charging speed and efficiency. EVs also have low-voltage batteries that are typically 12 volts. The power electronics in EVs are sometimes designed to provide power flow from the high-voltage batteries to the low-voltage batteries.

A high-voltage energy storage system for a power generator typically operates at voltages ranging from 1,000 volts to several hundred thousand volts depending on the scale of the system, with most utility-scale systems falling within the 100,000 to 500,000 volt range; considered “high voltage” according to electrical standards. Definition of high voltage generally includes voltages above 1,000 volts. High voltage is used for long-distance power transmission to minimize energy loss due to resistance through transmission lines. High voltage energy storage systems are commonly used in utility-scale power plants, large commercial buildings, and other large-scale applications.

Typically, the generator voltages used in the industry are 480 VAC, 4160 VAC, and 13,800 VAC. In case there's a power outage, the backup generators provide energy to the industrial machinery and equipment. The definition of low, medium, and high voltages can vary significantly depending on one's perspective and the standards being referenced. The NEC and ANSI/IEEE offer different definitions. According to the NEC, low distribution falls within the range of 0-49, while medium distribution is covered by 50-1000, and high distribution and transmissions 4160 & up are covered by 1000-4160. On the other hand, ANSI/IEEE defines medium voltage as ranging from 1 kV to 35 kV. From a practical standpoint, low voltage is considered to be 600 volts, placing medium voltage above this range. In industrial environments, 4160 volts is a common electric machine voltage, especially when motor horsepower exceeds 500. Medium voltage motors can range from 2400 to 6900 volts. While classical definitions of medium voltage extend up to 35 or even 69 kV, this range is more relevant from a utility/transformer perspective than from an onsite generator perspective.

It is well understood that methods that include one or more steps, the order listed is not a limitation of the claim unless there are explicit or implicit statements to the contrary in the specification or claim itself. It is also well settled that the illustrated methods are just some examples of many examples disclosed, and certain steps can be added or omitted without departing from the scope of this disclosure. Such steps can include incorporating devices, systems, or methods or components thereof as well as what is well understood, routine, and conventional in the art.

The connecting lines shown in the various figures contained herein are intended to represent exemplary functional relationships and/or physical couplings between the various elements. It should be noted that many alternative or additional functional relationships or physical connections can be present in a practical system. However, the benefits, advantages, solutions to problems, and any elements that can cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone can be present in an embodiment, B alone can be present in an embodiment, C alone can be present in an embodiment, or that any combination of the elements A, B or C can be present in a single embodiment; for example, A and B, A and C, B and C, or A and B and C.

In the detailed description herein, references to “one embodiment,” “an embodiment,” “an example embodiment,” etc., indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but can include other elements not expressly listed or inherent to such process, method, article, or apparatus.

While various embodiments of the disclosure have been shown and described, it is understood that these embodiments are not limited thereto. The embodiments may be changed, modified and further applied by those skilled in the art. Therefore, these embodiments are not limited to the detail shown and described previously, but also include all such changes and modifications.

What is claimed is:

1. A battery that is configured for serviceable integration into an energy storage system, the energy storage system having a management system for the battery, the battery comprising:
a cell arrangement that stores energy for operating the energy storage system; and
a display that is positioned at the battery and configured to receive service information from the management system and to display the service information that relates to the cell arrangement such that at least one of a serviceability and condition of the battery is decipherable by viewing the display.

2. The battery of claim 1, further including a processor that receives the service information, wherein the display is in communication with the processor via a circuitry.

3. The battery of claim 2, wherein the processor is integrated into a management system that manages the battery.

4. The battery of claim 3, wherein the management system is a battery management system for a high-voltage system.

5. The battery of claim 3, wherein the display is configured to operate when the energy storage system is turned off.

6. The battery of claim 3, wherein the management system is a battery management unit of the battery.

7. The battery of claim 2, wherein at least one of the display and the processor is selectively powered by the battery.

8. The battery of claim 1, further comprising a battery casing that encases the cell arrangement, and wherein the display is positioned at the casing.

9. The battery of claim 1, wherein the display is peripherally arranged at the battery such that the service information is decipherable at a glance from a vantage point that is external to the battery.

10. The battery of claim 1, wherein the service information includes indications of at least one of battery age, remaining life, state-of-health, state-of-charge, battery management system health, and faults.

11. The battery of claim 9, wherein the service information indicates a degree to which the battery is serviceable.

12. A battery pack for an electrified vehicle, the battery pack comprising:
a battery module arrangement that includes a plurality of battery modules, the battery module arrangement is configured to store energy for operating the electrified vehicle; and
at least one active display that is peripherally arrangeable at one or more of the battery modules in the plurality of batter modules or the battery pack, the active display is configured to readily display service information that relates to at least one of the battery modules in the plurality of battery modules such that serviceability of at least one of the battery module and the battery pack is readily decipherable by viewing the active display.

13. The battery pack of claim 12, further comprising a casing for arranging the plurality of battery modules into the battery module arrangement, wherein the at least one active display includes a peripheral display that is associated with each of the battery modules in the plurality of battery modules, and wherein the battery module arrangement is formed in an array such that the peripheral display of each of the battery modules in the plurality of battery modules is prominently displayed.

14. The battery pack of claim 13, wherein each of the at least one active display is arranged to be visible at a glance from a vantage point that is exterior to the battery module.

15. The battery pack of claim 12, wherein the at least one active display includes a scorecard that displays indicia of the service information for each of the battery modules in the plurality of battery modules.

16. The battery pack of claim 12, wherein the battery module arrangement further includes a processor that receives the service information, wherein the at least one active display is in communication with the processor via a circuitry, wherein the processor is integrated into a management system that manages the battery module arrangement, and wherein the service information includes indications of at least one of battery age, remaining life, state-of-health, state-of-charge, battery management system health, and faults.

17. A method of servicing a battery module, the method comprising:
receiving service information that relates to the serviceability of the battery module; and
displaying, via an active display that is viewable from a vantage point that is exterior to the battery module, the service information such that the service information is readily decipherable by viewing the active display.

18. The method of claim 17, further comprising indicating that the battery module is suitable for recycling or use in a second life energy storage system.

19. The method of claim 17, wherein the battery module is integrated into a plurality of battery modules in a battery pack, and wherein each of the battery modules has an associated active display, the method further comprising indicating whether to service one or more of the battery modules based on the associated active display of the battery module.

20. The method of claim 19, wherein the active display is associated with the battery pack, the method further comprising indicating that a battery module in the plurality of battery modules should be disabled or replaced via displaying on the active display a scorecard of at least one of battery health, charge, and readiness.
